(19) United States
(12) Patent Application Publication
(10) Pub. No.: US 2025/0072307 A1
(43) Pub. Date: Mar. 6, 2025

(54) PLANT REMOVAL TOOL AND METHOD

(71) Applicant: Garth St. Thomas, Garden Valley, CA (US)

(72) Inventor: Garth St. Thomas, Garden Valley, CA (US)

(21) Appl. No.: 18/806,419

(22) Filed: Aug. 15, 2024

Related U.S. Application Data
(60) Provisional application No. 63/535,492, filed on Aug. 30, 2023.

(51) Int. Cl. A01B 1/16

(52) U.S. Cl. CPC A01B 1/16

(57) ABSTRACT

A plant removal tool includes a pair of rods, a hinge connecting the rods, and gripping plates or jaws at bottom ends of the rods. The tool further includes a guide tube that is slidable along the rods. The guide tube may be slid up so that the jaws may be opened or may be slid down to force the jaws closed to engage a plant. The guide tube may also operate as a handle that may be used to hold the tool while the rods rotate within the guide tube. A top end of the tool may be configured for attachment to a drill so that the rods may be rotated while the jaws are closed on a plant, and the plant may be removed from the ground.

### REFERENCE TO RELATED APPLICATIONS

This patent document claims benefit of the earlier filing date of U.S. provisional Pat. App. No. 63/535,492, filed Aug. 30, 2023, which is hereby incorporated by reference in its entirety.

### BACKGROUND

Centaurea solstitialis or the yellow star-thistle is a thorny plant that has become an invasive nuisance and hazard in many areas, particularly the south and west of the United States. The presence of sharp long spines on seed heads of yellow star-thistle degrades livestock grazing, wildlife habitat, and recreational opportunities. The sharp spines also make star-thistle difficult to remove by hand. Devices and methods for removing star-thistle are therefore desired.

### SUMMARY

In accordance with the present disclosure, a plant or weed removal tool has jaws that can be closed to hold a plant such as star-thistle, while a drill may be used to turn the tool and rotate the plant free of the soil. The tool may include a pair of rods that are connected by a hinge and have gripping jaws or gripping plates at bottom ends of the rods. The top end of one of the rods may be attached to a drill so that the rods may be rotated while in a closed position. The tool may further include a guide tube that is slidable along the length of the rods. The guide tube may be slid up so that the jaws may be opened or may be slid down to force the jaws closed to grip a plant such as star-thistle. The guide tube also operates as a handle that may be used to hold the tool while the rods rotate within the guide tube.

One embodiment disclosed herein is a plant removal tool. The plant removal tool may include a first rod having a top end shaped to engage a drill, a second rod, a hinge attaching the second rod to the first rod, a first gripping plate at a bottom end of the first rod, a second gripping plate at a bottom end of the second rod, and a guide tube through which portions of the first rod and the second rod extend and in which the first rod and the second rod are rotatable. The guide tube may be free to slide between a closed position in which the guide tube holds the first gripping plate adjacent to the second gripping plate together and an open position in which the hinge allows the second rod to rotate relative to the first rod thereby separating the second gripping plate from the first gripping plate.

Another embodiment disclosed herein is a method for removing a plant from the ground. The method may use a tool including a first rod, a first gripping plate at a bottom end of the first rod, a second rod, a second gripping plate at a bottom end of the second rod, a hinge attaching the second rod to the first rod, and a guide tube through which at least a portion of the first rod extends. The method may include: sliding the guide tube up along the first rod; separating the second gripping plate from the first gripping plate and positioning the plant between the first gripping plate and the second gripping plate; sliding the guide tube down along the first rod, whereby the guide tube presses on portions of the first rod and the second rod and causes the first gripping plate and the second gripping plate to engage the plant; and rotating the first rod and the second rod about a length axis causing the plant to rotate for removal from the ground.

### BRIEF DESCRIPTION OF THE DRAWINGS

FIG. 1 shows a side view of a closed configuration of a tool in accordance with an example of the present disclosure.

FIG. 2 shows the closed configuration of the tool of FIG. 1 in a side view rotated by ninety degrees relative to FIG. 1.

FIG. 3 shows a side view of an open configuration of the tool of FIG. 1.

FIG. 4 shows the open configuration of FIG. 3 in a side view rotated by ninety degrees relative to FIG. 3.

FIG. 5 shows the tool of FIG. 1 when attached to a drill and closed on a plant such as star-thistle.

The drawings illustrate examples for the purpose of explanation and are not of the invention itself. Use of the same reference symbols in different figures indicates similar or identical items.

### DETAILED DESCRIPTION

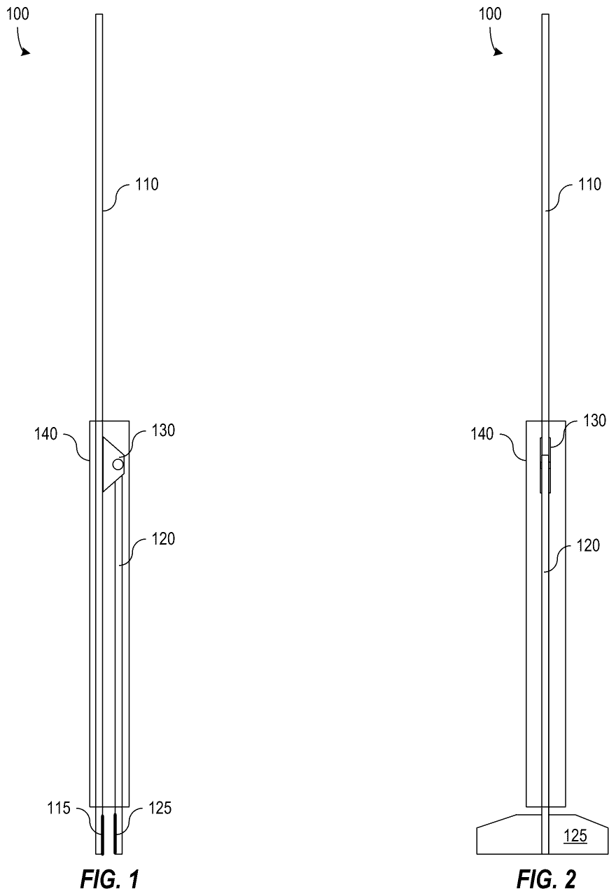

FIGS. 1 and 2 show side views of a closed configuration of a tool 100 in accordance with an example of the present disclosure. Tool 100 includes a rod 110 and a rod 120 that are joined by a hinge 130. In the illustrated example, rod 120 is shorter than rod 110 and hinge 130 attaches a top end of rod 120 to a location along the length of rod 110. For example, the length of rod 110 above hinge 130 may be about equal to the length of rod 110 below hinge 130. Each rod 110 or 120 has a jaw or gripping plate 115 or 125 at or near its bottom end. A top of rod 110 may be tri-flatted or otherwise configured so that the top end of rod 110 may be securely held in the chuck of a standard drill or other rotation device. Rods 110 and 120 and gripping plates 115 and 125 may be made of a durable material, for example, a metal such as iron or steel.

Tool 100 also includes guide tube 140 through which rods 110 and 120 extend. FIGS. 1 and 2 illustrate an example where guide tube 140 is transparent, making rods 110 and 120 and hinge 130 visible in FIGS. 1 and 2, but guide tube 140 may alternatively have any opacity or color. Guide tube 140 may be free to slide relative to rods 110 and 120, and FIGS. 1 and 2 show guide tube 140 slid down to near or touching tops of gripping plates 115 and 125. An inner diameter of guide tube 140 and the size and placement of gripping plates 115 and 125 are such that guide tube 140 being slid down forces gripping plates 115 and 125 towards each other to grip or otherwise engage a plant such as star-thistle.

In one specific embodiment, rods 110 and 120 are 5/16″ diameter iron rods with rod 110 be about 32.5″ long and rod 120 be about 11.5″ long. Plates 115 are iron plates about 4.5″ wide, 1″ high, and ⅛″ thick. Guide tube 140 may be a ¾″ diameter tube, e.g., ¾″ PVC pipe, about 18.5″ long, and hinge 130 and rods 110 and 120 may be sized and positioned to fit within guide tube 140 when gripping plates 115 and 125 contact each other.

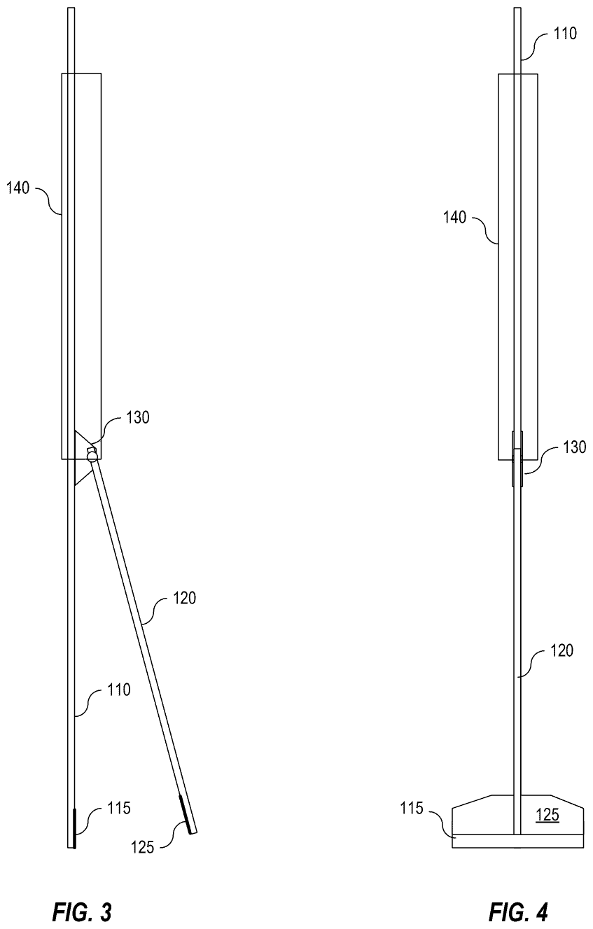

FIGS. 3 and 4 show side views of an open configuration of tool 100. For the open configuration, guide tube 140 is slid up rod 110 allowing hinge 130 to open so that gripping plates 115 and 125 can move relative to or separate from each other. In particular, plate 125 and the bottom end of rod 120 may be swung away from plate 115 and the bottom end of rod 110. The length of guide tube 140 may be about equal to or less than the length of rod 110 extending above hinge 130, so that guide tube 140 may be slid up but remain on rod 110 while rod 120 is free to rotate about hinge 130.

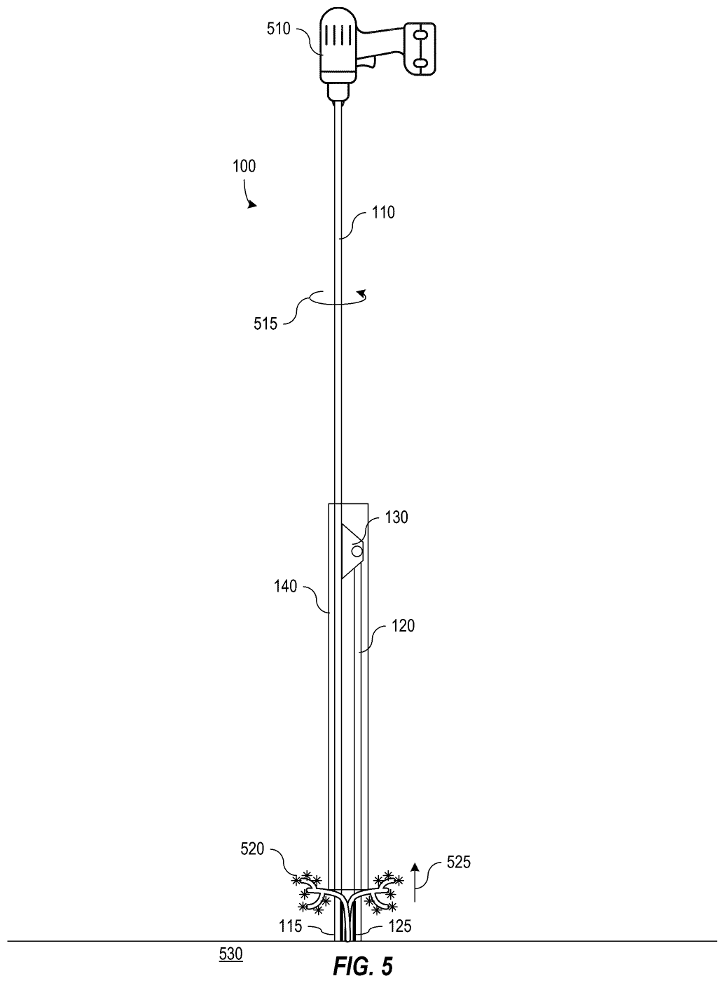

FIG. 5 illustrates use of tool 100 for removal of a plant such as star-thistle 520 from the ground 530. For a plant removal process, guide tube 140 may have been slid up rod 110 so that tool 100 may be opened as illustrated in FIGS. 3 and 4. The gripping plates 115 and 125 may then be placed on opposite sides of plant 520, before guide tube 150 is slid down pressing on portions of rods 110 and 120 and closing gripping plates 115 and 125 on plant 520. The closing of gripping plates 115 and 125 engages tool 100 with plant 520 without requiring a user to touch plant 520, so that the user of tool 100 may avoid any thorns of the plant 520. A drill 510 or similar rotating device is attached to tool 100, particularly to rod 110, so that drill 510 may rotate at least a portion tool 100 about a length axis of rod 110. The user of tool 100 may hold guide tube 140 while operating drill 510 to cause rotation or spinning 515 of rod 110, which causes both rods 110 and 120 to spin within guide tube 140 and also spins gripping plates 115 and 125 and plant 520. Alternatively, the user of tool 100 may hold and operate drill 510 and allow guide tube 140 to rotate with rods 110 and 120 and plant 520. Lifting 525 of tool 100 during the spinning 516 of at least some types of plants, particularly star-thistle, has been found to remove the plant including roots of the plants from the ground. Guide tube 140 can then be slid up rod 110, allowing gripping plates 115 and 125 to open and tool 100 to drop the removed plant 520, again without requiring the user to touch the plant 520.

Terms such as up, down, top, and bottom are used herein to distinguish relative directions or positions of features, items, or structures. Such relative terms are arbitrary in that they depend on orientations. For example, a 180° change in orientation may make the top become the bottom and the bottom become the top, and a 90° change in orientation may make the top become right-most and the bottom become left most.

Although particular embodiments have been disclosed, these embodiments are only examples and should not be taken as limitations. Various adaptations and combinations of features of the embodiments disclosed are within the scope of the following claims.

What is claimed is:

1. A plant removal tool comprising:
a first rod;
a second rod;
a hinge attaching the second rod to the first rod;
a first gripping plate at a bottom end of the first rod;
a second gripping plate at a bottom end of the second rod; and
a guide tube through which portions of the first rod and the second rod extend and in which the first rod and the second rod are rotatable, the guide tube being free to slide between a closed position in which the guide tube holds the first gripping plate adjacent to the second gripping plate together and an open position in which the hinge allows the second rod to rotate relative to the first rod thereby separating the second gripping plate from the first gripping plate.

2. The plant removal tool of claim 1, wherein
the second rod is shorter than the first rod; and
the hinge attaches a top end of the second rod to the first rod at a location between the bottom end of the first rod and a top end of the first rod.

3. The plant removal tool of claim 2, wherein the guide tube is longer than a distance between the first gripping plate and the hinge.

4. The plant removal tool of claim 1, wherein the first rod has a top end shaped to engage a drill.

5. A method for removing a plant from the ground using a tool including a first rod, a first gripping plate at a bottom end of the first rod, a second rod, a second gripping plate at a bottom end of the second rod, a hinge attaching the second rod to the first rod, and a guide tube through which at least a portion of the first rod extends, the method comprising:
sliding the guide tube up along the first rod;
separating the second gripping plate from the first gripping plate and positioning the plant between the first gripping plate and the second gripping plate;
sliding the guide tube down along the first rod, the guide tube pressing on portions of the first rod and the second rod and thereby causing the first gripping plate and the second gripping plate to engage the plant; and
rotating the first rod and the second rod about a length axis causing the plant to rotate for removal from the ground.

6. The method of claim 5, wherein the plant is yellow star thistle.

7. The method of claim 5, wherein rotating the first rod and the second rod comprise operating a drill attached to a top end of the first rod.

8. The method of claim 7, further comprising holding the guide tube while operating the drill so that portions of the first rod and the second rod rotate within the guide tube.
